(19) United States
(12) Patent Application Publication
(10) Pub. No.: US 2007/0256373 A1
(43) Pub. Date: Nov. 8, 2007

(54) INSULATED WINDOW PANELS

(76) Inventor: Allison COLLARD, Jupiter, FL (US)

Correspondence Address: WILLIAM COLLARD;COLLARD & ROE, P.C., 1077 NORTHERN BOULEVARD, ROSLYN, NY, 11576, US

(21) Appl. No.: 11/379,599

(22) Filed: Apr. 21, 2006

(51) Int. Cl. E06B 3/26

(52) U.S. Cl. 52/202

(57) ABSTRACT

An insulated window covering for mounting over the external surface of a window frame in a building having a flat planar sheet of material designed to substantially cover the external surface of the window, and having a flat planar sheet of insulation secured to one surface of the sheet of material adjacent to the window surface to form an insulated panel. Fasteners secure the insulated panel to the building and consist of L-brackets. The insulated panels are easily attachable and detachable to the window openings of the building and are used to insulate the building in summer and winter to provide savings in energy costs.

### BACKGROUND OF THE INVENTION

1. Field of the Invention

The present invention relates to insulated window panels for use over windows of residential homes or commercial buildings for the purpose of saving energy and protecting the windows from violent storms.

In many areas of the south, such as Florida, it is desirable to keep the sun from entering through the windows and heating up the building. For many residents of the south, the afternoon sun, especially during the summer, is almost at its zenith in the sky, and therefore windows on the east and west sides of the buildings will receive a great deal of direct sunlight that causes an undesirable heating of the house. This effect requires an increased use of air conditioning during these times. Any attempt to block the sun on the interior of the house, such as with the use of shades, awnings or blinds, will still allow much of the sun to heat the interior coverings, and thus spread the heat into the interior of the building.

### SUMMARY OF THE INVENTION

Accordingly, the present invention provides an apparatus for completely covering some or if not all of the windows on the east and west, or other sun exposed areas of the building by using a rigid window covering together with an insulated backing to form an insulated panel to completely block out the light and heat from entering the building. This is useful especially when the occupants of the house or building have to be away for any lengthy period of time, and have to leave the air conditioning turned on during their absence.

2. The Prior Art

In the prior art, there are many types of external window coverings, such as hinged shutters, roll-down awnings, and other devices that will keep the sun or heat partially from entering the house, but will not especially keep the heat from entering through the windows during the mornings and afternoons when the sun is shining on these windows. Moreover, many of these external shutters and awnings do not contact the windows and thus create a heated chamber between the outside surface of the windows and the shutters. This further allows heat to be transmitted into the building.

Accordingly, the present invention provides rigid window coverings having a layer of insulation cemented to one side of the rigid coverings to form an insulated panel so that the coverings can be placed against the windows, with the insulation contacting the windows or the window mullions to block both the heat and the light from coming into the building. By mounting the insulated rigid window coverings flush to the windows, or window mullions, the coverings and the insulation prevent both the heat and light from entering the building, with a minimum of any air pockets or no air pockets between the windows and the externally mounted window panels. The insulation may consist of any sheet insulation material, such as Styrofoam sheeting or fiberglass that can be cemented to the rigid surface, such as a sheet of aluminum, metal such as galvanized or stainless steel, sheet vinyl or fiberglass. Suitable angle brackets mounted along the periphery of the rigid insulated panel will allow the panel to be detachable secured to the edges and periphery of the window openings or inside the window recesses of the building, thereby preventing their accidental removal by wind or gravity. The brackets may consist of any elongated L-brackets that may be affixed to either the wood or cement around the recessed window edges in suitable locations, so as to retain the rigid insulated panels flush against the windows. Suitable fasteners such as screws or quick release hardware can be provided to secure the panels to the brackets so that they can be easily removed when there is a change in season and the occupants return to the house. The window panels may also be hinged to opposite sides of the window openings so that they can be easily opened and closed as needed. By designing the rigid insulated window panels so that its insulation is maintained tightly against the windows or window mullions, very little heat if any, is transmitted into the building. Moreover, the rigid outer surface of the window coverings if constructed of metals such as sheet aluminum, will reflect away the sunlight, further reducing the heat transfer through the panel.

In northern climates where the outside of the building is much colder than the heated inside, and where the occupants will be away for any significant period of time, it is also desirable to cover the windows with the same insulated rigid window panels. This will prevent the heat within the building from being transferred more quickly through the windows than through the side walls of the building. Thus, by covering the windows with the insulated flat panels, a great deal of the heat loss through the windows can be eliminated even if the windows are thermopane windows, and are tinted. The insulated panels also serve to protect the windows from damage caused by high winds and storms, flying debris, and from vandals. Moreover the insulated panels add strength to the window openings and protect the windows from imploding during hurricanes.

### BRIEF DESCRIPTION OF THE DRAWINGS

Other objects and features of the present invention will become apparent from the following detailed description considered in connection with the accompanying drawings which disclose the embodiments of the invention.

In the drawings, wherein similar reference characters denote similar elements throughout the several views:

FIG. 1 shows a front perspective view of the inventive window coverings installed in the window recess along the side wall of a building;

FIG. 2a is a perspective view of an individual panel with its insulated backing;

FIG. 2b is a cross-sectional view of FIG. 2a taken along line 2b-2b;

FIG. 3 shows another embodiment of an insulated window panel that is hinged to the window recess of the building for easy opening and closing of the panels;

FIG. 4 shows another embodiment of the invention wherein the edges of the insulated panel have right angle flanges for securement to the building; and

FIG. 5 shows still a further embodiment of the invention wherein the edges of the panel have straight flanges to contact the wall of the building.

### DETAILED DESCRIPTION OF PREFERRED EMBODIMENTS

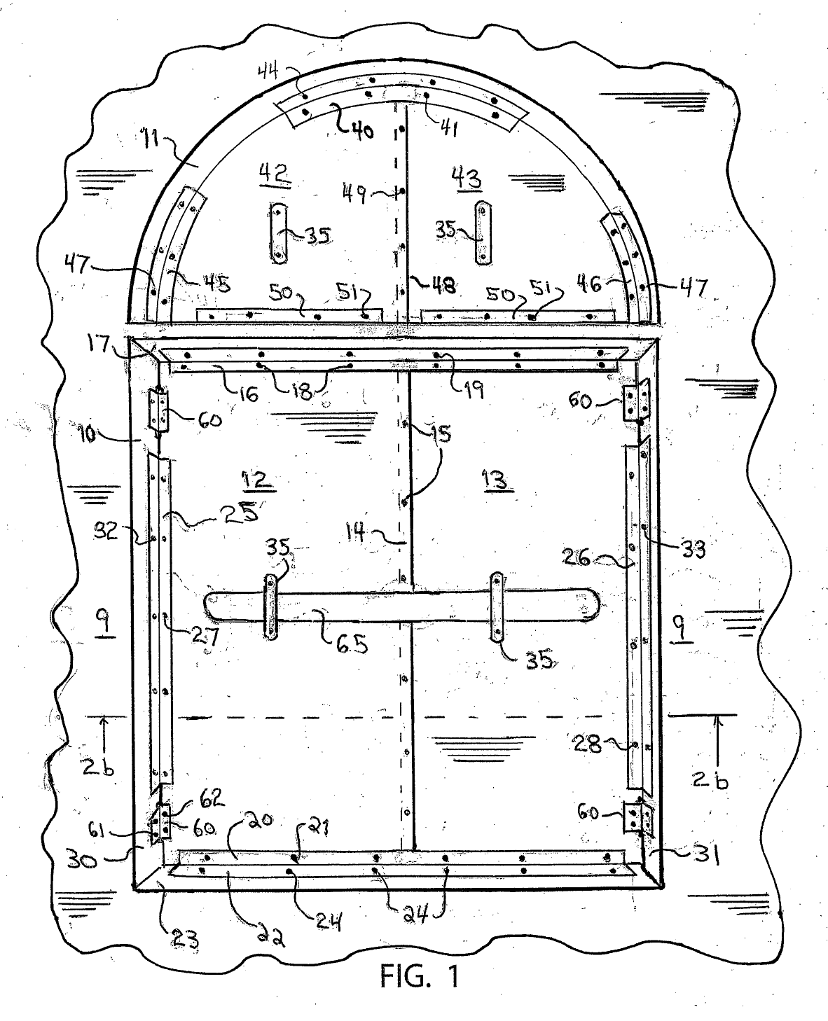

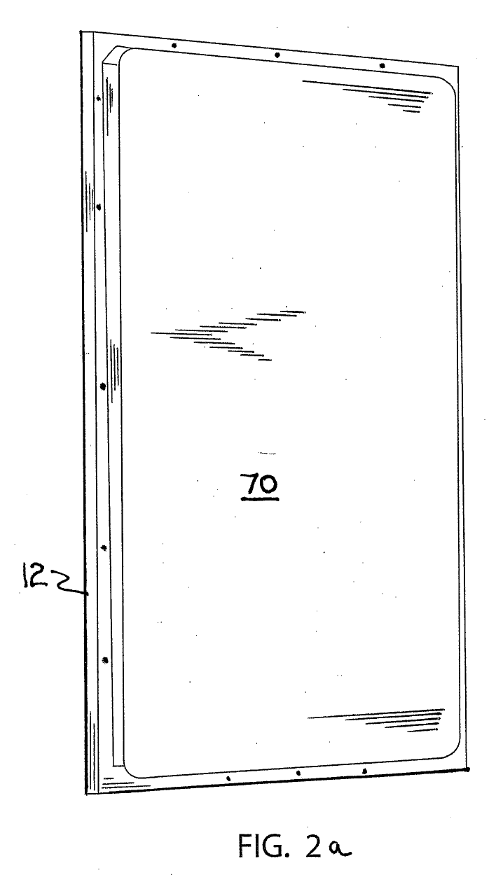

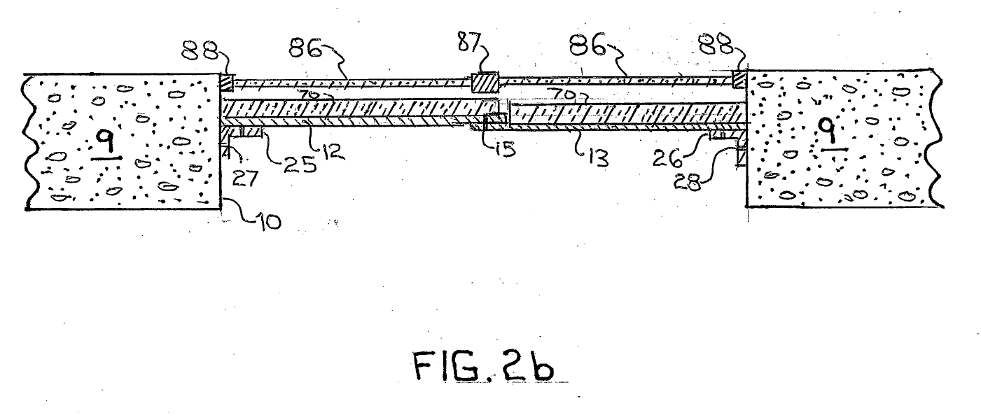

Turning now in detail to the drawings, referring to FIGS. 1, 2a and 2b, there is shown a rectangular window opening 10, and a semi-circular sunburst window opening 11 formed in the building wall 9. Set into rectangular window opening 10 in the building are two rigid flat panels 12 and 13, which substantially cover the windows 86 mounted in that rectangular opening 10. Rigid panels 12 and 13 may consist of a single sheet of aluminum, vinyl, galvanized sheet metal, or other metal, fiberglass, or other rigid material to completely cover rectangular opening 10. Panels 12 and 13 more conveniently, can be split into two panels, as shown, with a detachable and overlapping seam 14 running vertically through the center of the panels. Panels 12 and 13 are designed to overlap each other by an amount sufficient to allow fasteners such as screws 15 to join the panels together, along their overlapped portions 14. At the top edge of the panels and inserted into rectangular recess 10 is an L-bracket 16 spanning substantially the width of panels 12 and 13. The lower portion of L-bracket 16 overlaps the top edge of panels 12 and 13. The other portion of L-bracket 16 is bent at 90° so as to allow securement to the top inside surface 17 of rectangular recess 10. Suitable fasteners 18 will connect L-bracket 16 to the top of panels 12 and 13. Likewise, a plurality of fasteners 19 will secure the top portion of L-bracket 16 to the overhanging recessed portion 17 of rectangular recess opening 10. If the building is constructed of cement block or other rigid material, suitable cement screws 19 would be used to bolt L-bracket 16 to the building structure.

In a similar manner, elongated L-bracket 20 is secured by means of fasteners 21 to the bottom edge of panels 12 and 13. The other portion 22 of L-bracket 20 bent at 90° will be secured to sill 23 of recess 10 by means of suitable fasteners 24.

Along the left and right hand vertical side surfaces of recess opening 10 are also provided L-brackets 25 and 26 which are fastened to the vertical periphery of panels 12 and 13 by means of fasteners or screws 27 and 28. Likewise, the other portion of L-brackets 25 and 26, bent at 90° which abut the jamb, or sidewalls of the recess 30 and 31 are fastened or screwed by means of suitable fasteners 32 and 33 to the building jamb surface. If two flat panels 12 and 13 are used, they can be easily installed after the four opposing L-brackets are permanently mounted to the building by sliding them into the brackets. Thus, if the upper bracket 16 has a larger vertical overlap to panels 12 and 13, than the lower L-bracket 20, then panels 12 and 13 can be first slid upward so that their top edges fit inside the horizontal space of L-bracket 16. This allows the lower edge to sweep over the top surface of L-bracket 20 and drop slightly downward into the space defined by lower L-bracket 20 to rest on the edge of the sill, without the panels disconnecting themselves from the upper bracket. This can easily be accomplished by making L-bracket 16 overlap panels 12 and 13 by about one inch and allowing lower bracket 20 to only overlap the bottom edge of panels 12 and 13 by ½ inch. Panels 12 and 13 would thus be slightly shorter in length than the vertical dimension of recess 10 by slightly more than ½ inch to allow the panels to be slipped into the oppositely mounted brackets.

With panels 12 and 13 being constructed of thin, rigid material such as vinyl or aluminum, they can be made to overlap each other and then slid sideways in opposite directions to engage inside vertical L-brackets 25 and 26 before being fastened to those brackets. Once the outside vertical edges of panels 12 and 13 are secured to their corresponding L-brackets 25 and 26, then fasteners 15 can be tightened along seam 14 to prevent any more horizontal movement of panels 12 and 13. Likewise, the remaining fasteners 18, 21, 27 and 28 can be inserted into the peripheral brackets 16, 25, 20 and 26.

To further facilitate the installation of flat panels 12 and 13, handles 35 with hollow handgrips are preferably provided bolted to the approximate center of the panels so that they can be moved up and into the top and bottom panels and slid sideways to engage the side panels, as described above.

In a similar manner, recess 11 designed to receive a sunburst-type window (not shown) will be fitted with an arc shaped L-bracket 40 along its top inside surface. L-bracket 40 has been bent and formed to fit into the arc shape of the semi-circular recess 11 and would contain suitable fasteners 41 to secure to arc-shaped panels 42 and 43. In a similar manner, fasteners 44 on the other portion of L-bracket 40 will secure the bracket to the inside top portion of semi-circular recess 11. Additional side brackets 45 and 46 having a slight arc-shape bend, will fit into recess 11 to secure the lower edges of panels 42 and 43 to the building by means of fasteners 47. In a manner similar to the lower rectangular panels, the upper arc-shaped panels 42 and 43 are designed to overlap in a seam 48 and will be secured together by suitable fasteners such as screws 49. An elongated lower L-bracket 50, having a vertical height less than the vertical drop of bracket 40 will thus allow panels 42 and 43 to be likewise inserted upward and over bottom bracket 50 before being dropped down behind the edge of bracket 50 without being disengaged from upper arc-shaped bracket 40. Obviously, panels 42 and 43 will have a vertical dimension slightly less than the height of semi-circular recess 13 to allow them to be slipped into the brackets, and secured by 47, 44, 49 and 51.

All of the L-shaped brackets are designed so that the surface, contacting the sill and jamb portions of the window openings 10 and 11 will be secured permanently, either by cement screws, rivets, or other means and will not normally have to be removed thereafter. Thus, only the fasteners connecting to the peripheral edges of the flat panel to the brackets need to be removed each time the panels are removed at the change of the season.

For smaller size windows, only a single insulated panel need be used and can be bent and fixed into the bracket arrangement with suitable dimensions.

To add additional protection in the event of high winds, a horizontal crossbar 65 can be inserted thru the handgrip openings of handle 35 to add further rigidity to the mounted panels.

In place of using the L-brackets, suitable hinges 60 can also be mounted, joining panels 12 and 13 to the building jamb surfaces by means of hinge fasteners 61 and 62. In this case it would not be necessary to remove panels 12 and 13, but only swing them open as needed on their hinges 16 and when fully opened clamp them to the walls of the building.

Referring to FIG. 2a, there is shown a prospective view of the backside of a typical rectangular panel 12 onto which is cemented a sheet of insulation 70 in the form of a foam pad substantially covering the backside of panel 12. Foam pad 70 is designed so that one edge is recessed back from the four peripheral edges of panel 12 so as to allow the edges of panels 12 and 13 to overlap on seam 14 and to allow their easier horizontal movement within recess frame 10 during installation.

FIG. 2b shows a cross-sectional view of the mounted insulated panels along line 2b-2b of FIG. 1, secured in recess 10 against windows 86 with its center mullion 87 and side frame 88. Panels 12 and 13 with thus attached insulation pads 70 are mounted as close as possible to the surface of windows 86, and may even touch frames 88 to minimize the air gap between them.

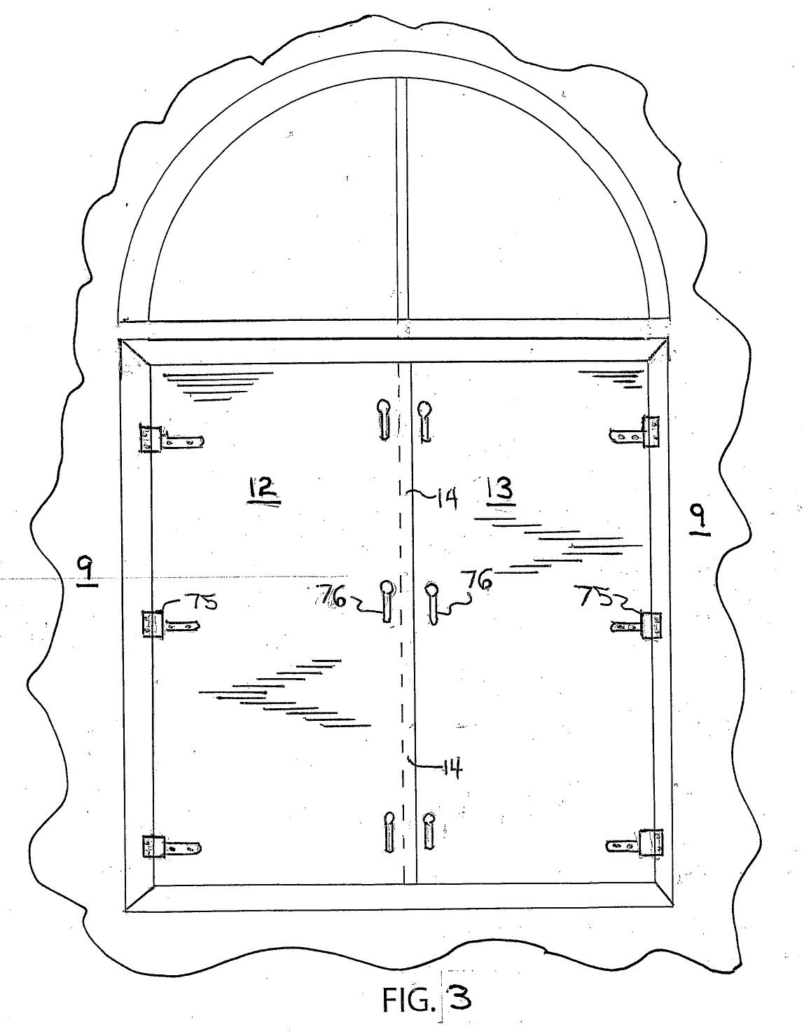

FIG. 3 shows a hinged variation of the panels having cabinet type hinges 75 secured to the panels and the window opening 10 of the building. Along seam 14 is pivotably mounted release and locking handles 76 for closing and locking panels 12 and 13 together when the panels are closed and abut each other. Locking handles 76 are similar to those used to close the back doors of trucks, and may include a vertically moving rod (not shown), the ends of which engage into openings formed in sill 23 and top jam 17.

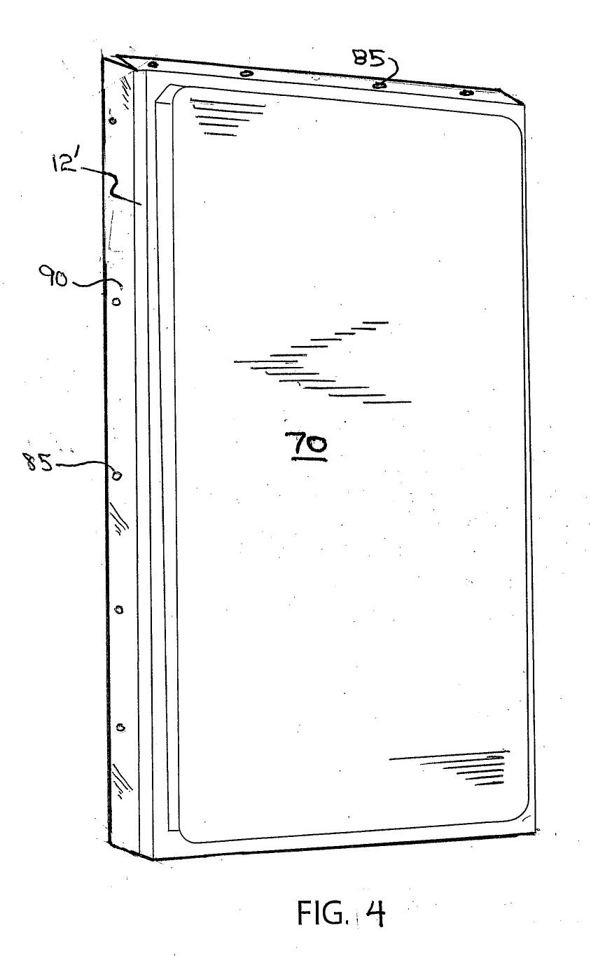

FIG. 4 shows another embodiment of the invention wherein the insulated panel 12′ has been made with right angle flanges formed along the peripheral edges of the panel, and extending 90° away from insulation pad 70. Here, screw holes 85 can be formed in the flanges to allow the flanges, instead of brackets, to be used to mount the insulated panels to the recessed window surfaces. These panels with their flanges, would thus have to be dimensionally accurate to fit snugly into recessed window surfaces 10.

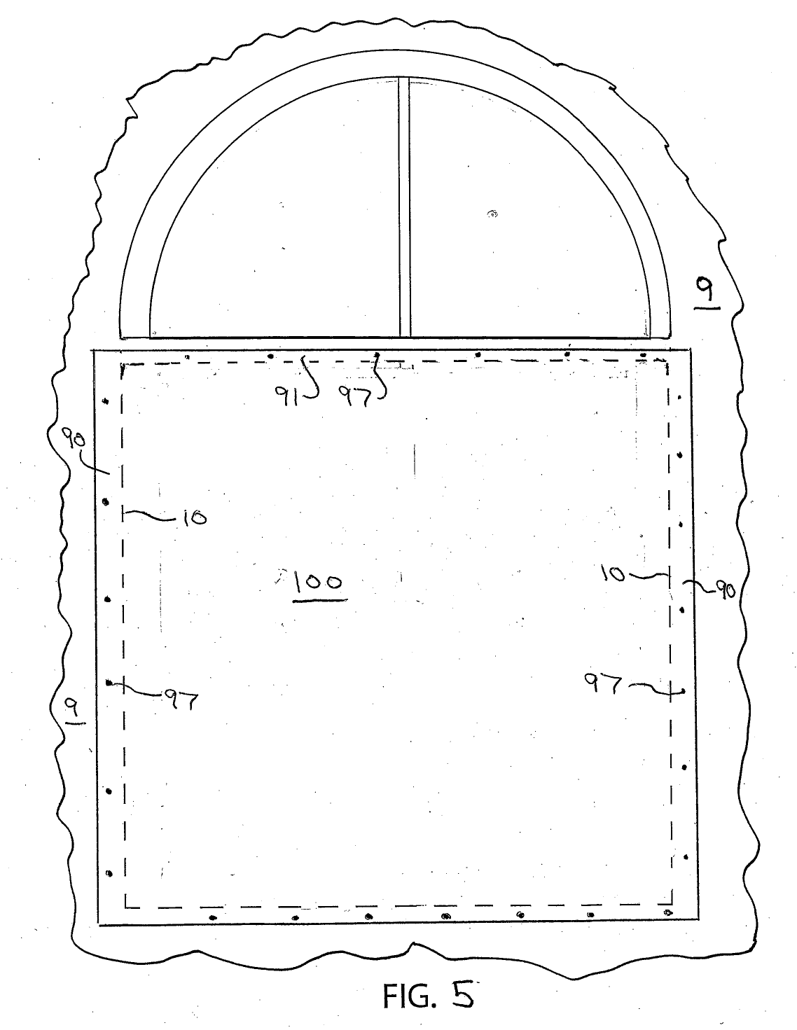

FIG. 5 shows another embodiment of the invention wherein rigid flat panel 100 is constructed with extended flanges 95 and 96, designed to contact and mount to the outside surface 9 of the building, adjacent to window recess 10. Here screw fasteners inserted in holes 97 would mount the insulated panels almost flush with the building wall. To fill up the air gap between insulation pad 70 and the outside surface of the window, additional thickness of insulation would have to be added to pad 70.

In an actual construction of rigid panel 12, flat aluminum sheet was used, which had a thickness between 0.062 to 0.090 inches for panels that were approximately 3 feet wide by 6 feet tall. The insulating sheet 70 was constructed of polystyrene foam, or styrofoam ¾″ thick, which had a heat insulation R factor of slightly less than 10. Polyurethane foam could also be used. Fiberglass with a finished aluminum surface could also be used as the insulator.

The fasteners used to hold the insulated panels may be any metal L-brackets, hinges, magnetic holders, snap couplings, screws or other commonly known hardware.

During an actual experimental test, the panels, when mounted with the L-brackets, withstood the force of hurricane Wilma, with winds exceeding 110 m.p.h. without any damage. Moreover, the panels protected the windows to which they covered, from any flying debris or damage.

In the six month period of time in which the panels were used during the late spring, summer and early fall season in Florida, they resulted in reducing the electric bills for a 3,000 sq. ft. home, to approximately 25% of what they were the previous year by blocking the heat coming through the windows.

Accordingly, while a few embodiments of the present invention have been shown and described, it is to be understood that many changes and modifications may be made thereunto without departing from the spirit and scope of the invention as defined in the appended claims.

What is claimed is:

1. An insulated window covering for mounting over the external surface of a window in a building comprising
a flat planar sheet of material having the dimensions to substantially cover the external surface of the window;
a flat planar sheet of insulation coupled to one surface of said planar sheet of material to be mounted adjacent to the window surface to form an insulated panel; and
at least one fastener for securing the insulated panel to the building.

2. The window covering as recited in claim 1, wherein said flat sheet of material comprises aluminum.

3. The window covering as recited in claim 2, wherein said sheet of insulation comprises Styrofoam insulation cemented to one side of said aluminum sheet to form said panel.

4. The window covering as recited in claim 1, wherein said at least one fastener comprises brackets for securing the edges of said insulated panel to the building.

5. The window covering as recited in claim 5, wherein said brackets have a plurality of holes for allowing screws to be inserted in the holes to connect said brackets to said insulated panels and the surface of the building.

6. The window covering as recited in claim 4, wherein the window is mounted in a recessed opening of the building wall and said insulated panel is constructed slightly smaller than the recessed window opening of the building so as to fit against the building window.

7. The window covering as recited in claim 6, wherein said brackets are secured to the recessed surfaces surrounded the window and to the peripheral edges of said panel.

8. The window covering as recited in claim 7, wherein said flat panel comprises two panels having adjacent edges that overlap each other and span the opening of the window recess; and
fasteners disposed in the overlapping edges for securing the overlapped edges to each other.

9. The window covering as recited in claim 8, wherein said brackets comprise a first bracket mounted along the bottom surface of the recessed opening so as to define a first channel for receiving the bottom edge of said panels, and;
a second bracket mounted along the top surface of the recessed opening so as to define a second channel that is deeper than said first channel and wherein said insulated panels have a length sufficient to be inserted into said second channel, and slid over the top of said first bracket so that said panels can nest into said first channel without becoming disengaged from said second.

10. The window covering as recited in claim 9, wherein said brackets further comprise a pair of vertical brackets each mounted along the side surfaces of the recessed opening and each defining a vertical channel to receive the vertical edges of said insulated panels so that after said panels engaged with said first and second brackets, said panels can be slid opposite to each other to engage into the vertical channels while their adjacent edges overlap each other to seal over the recessed opening.

11. An insulated window covering for mounting over the external surface of a window that is recessed in a building wall comprising:
a flat planar sheet of material dimensioned so as to substantially fit into the recessed opening of the window, said material having a portion of its peripheral edges bent outward at right angles away from the window surface so as to form peripheral rim surfaces to abut the inside surfaces of the window recess;
a flat planar sheet of insulation material secured to one surface of said flat planar sheet of material adjacent to the window surface as to form an insulated panel;

12. The window covering as recited in claim 11, wherein said peripheral rim surfaces of said panel, abutting the window recesses are provided with fasteners coupled to the surfaces of the recessed opening so as to detachable secure the insulated panel to the peripheral surfaces of the window opening.

13. The window covering as recited in claim 12, wherein said fasteners comprise a plurality of screw holes formed around the right hand angled peripheral rim surfaces of said planar sheet of material, and screws coupled thru said screw holes for attaching the panel to the recessed surfaces of the building wall adjacent to the window.

14. The window covering as recited in claim 11, wherein said flat planar sheet of material is aluminum.

15. The window covering as recited in claim 11, wherein said overlapped panels are each provided with a handle horizontally aligned and mounted approximately in the center of each panel.

16. The window covering as recited in claim 11, comprising a crossbar horizontally disposed and coupled through each of said handles for detachable securement to said handles.

17. The window covering as recited in claim 11, wherein said flat panel comprises two panels wherein their adjacent edges overlap each other; and
fasteners disposed in the overlapping edges for securing the overlapped edges to each other.

18. The window covering as recited in claim 8, wherein said flat planar sheet of material is vinyl.

19. The window covering as recited in claim 8, wherein said flat planar sheet of material is galvanized sheet metal.

20. An insulated window frame covering for mounting in the recess of a window frame in a building comprising
a flat planar sheet of material having the dimensions to substantially cover the external surface of the window frame;
a flat planar sheet of insulation secured to one surface of said planar sheet of material adjacent to the window surface to form an insulated panel, said flat planar sheet of material having extending flanges on its edges for contact with the building wall along the peripheral edges of the recess for the window.
